(19) United States
(12) Patent Application Publication
(10) Pub. No.: US 2025/0369804 A1
(43) Pub. Date: Dec. 4, 2025

(54) Systems and Methods for Integrated Cavity Optomechanical Thermal Imaging Transducer

(71) Applicant: The Regents of the University of California, Oakland, CA (US)

(72) Inventors: Chee Wei Wong, Los Angeles, CA (US); Jaime Flor Flores, Van Nuys, CA (US); Talha Yerebakan, Los Angeles, CA (US)

(73) Assignee: The Regents of the University of California, Oakland, CA (US)

(21) Appl. No.: 19/225,792

(22) Filed: Jun. 2, 2025

Related U.S. Application Data
(60) Provisional application No. 63/654,684, filed on May 31, 2024.

(51) Int. Cl. G01J 5/44; G01J 5/00

(52) U.S. Cl. CPC G01J 5/44; G01J 2005/0077

(57) ABSTRACT

Systems and methods for an optomechanical thermal imager in accordance with embodiments of the invention are illustrated. One embodiment includes an optomechanical thermal imager. The optomechanical thermal imager includes at least one optomechanical thermal sensor, wherein the optomechanical thermal sensor includes a deformable structure configured to receive infrared radiation and undergo a mechanical deformation in response to thermal energy from the radiation, an optical resonator mechanically coupled to the deformable structure and configured to shift in resonance condition in response to the deformation, and a probe source configured to emit light toward the optical resonator at a wavelength near the resonance condition. The optomechanical thermal imager further includes a detector configured to receive light from the optical resonator and generate an output based on a shift in the resonance condition associated with the received infrared radiation.

### CROSS-REFERENCE TO RELATED APPLICATIONS

The current application claims the benefit of and priority under 35 U.S.C. § 119(e) to U.S. Provisional Patent Application No. 63/654,684 entitled “Integrated Cavity Optomechanical Thermal Imaging Transducer” filed May 31, 2024, the disclosures of which are hereby incorporated by reference in their entirety for all purposes.

### FIELD OF THE INVENTION

The present invention relates generally to thermal imaging, and more specifically to thermal imaging transducers using optomechanical cavities.

### BACKGROUND

Thermal imaging devices are sensors that detect infrared radiation emitted by objects and convert it into a visual representation of temperature distribution. Unlike visible light cameras, which rely on reflected light, thermal imagers capture the heat signatures of objects, allowing them to function in complete darkness or through obscurants like smoke and fog. These devices typically use uncooled or cooled infrared detectors, such as microbolometers or photon detectors, which are sensitive to mid- or long-wave infrared wavelengths. Thermal imaging can be used in a variety of application including military and surveillance applications, industrial inspection, firefighting, medical diagnostics, and building energy audits to offer a non-contact, real-time method to monitor heat-related phenomena and identify anomalies invisible to the naked eye.

Thermal imaging devices can be implemented by integrating an infrared-sensitive detector array with optics, signal processing electronics, and display systems. Incoming infrared radiation can be focused onto the detector array, which senses temperature-dependent variations in emitted thermal energy. In uncooled systems, microbolometers absorb infrared radiation and change resistance in response to heat, while cooled systems use cryogenically cooled photodetectors for higher sensitivity and resolution. The detector signals are digitized and processed using image enhancement algorithms to produce a thermal image, often color-coded to represent different temperature ranges.

### SUMMARY OF INVENTION

Systems and methods for an optomechanical thermal imager in accordance with embodiments of the invention are illustrated. One embodiment includes an optomechanical thermal imager. The optomechanical thermal imager includes at least one optomechanical thermal sensor, wherein the optomechanical thermal sensor includes a deformable structure configured to receive infrared radiation and undergo a mechanical deformation in response to thermal energy from the radiation, an optical resonator mechanically coupled to the deformable structure and configured to shift in resonance condition in response to the deformation, and a probe source configured to emit light toward the optical resonator at a wavelength near the resonance condition. The optomechanical thermal imager further includes a detector configured to receive light from the optical resonator and generate an output based on a shift in the resonance condition associated with the received infrared radiation.

In another embodiment, the deformable structure further includes a stationary support portion anchored to a substrate, and a suspended mass coupled to the stationary support portion, wherein the suspended mass forms at least a portion of the optical resonator or being mechanically coupled to a portion of the resonator such that deformation of the suspended mass causes a shift in the resonator's resonance condition.

In a further embodiment, the deformable structure further includes an infrared-absorbent layer thermally coupled to the structure and configured to convert incident infrared radiation into localized heat.

In still another embodiment, the optical resonator includes a photonic crystal cavity suspended above a substrate.

In a still further embodiment, the optical resonance condition includes a resonance frequency that changes with mechanical deformation of the resonator.

In yet another embodiment, the probe source is configured to emit light at a wavelength detuned from a baseline resonance of the optical resonator.

In a yet further embodiment, the detuning induces an optical gradient force that modulates an effective mechanical stiffness of the structure.

In another additional embodiment, the output includes a temperature value determined based on a known temperature coefficient of frequency associated with the optical resonator.

In a further additional embodiment, the at least one optomechanical thermal sensor is arranged in an array to form an optomechanical thermal imager.

In another embodiment again, further including a signal processor configured to generate a spatially resolved thermal image based on the output of the detector.

In a further embodiment again, further including an integrated waveguide for optical coupling from the probe source to the optical resonator.

One embodiment includes a method of sensing infrared radiation using an optomechanical cavity, the method including absorbing infrared radiation at a deformable structure thermally coupled to an optical resonator, and inducing a deformation in the deformable structure in response to absorption of the infrared radiation. The method further includes shifting an optical resonance condition of the optical resonator due to the deformation, probing the optical resonator with a light signal, and detecting a change in the optical signal that indicates the resonance shift and corresponds to the absorbed infrared radiation.

In still yet another embodiment, the deformable structure comprises a suspended structure coupled to the optical resonator.

In a still yet further embodiment, the optical resonator comprises a photonic crystal cavity suspended above a substrate.

In still another additional embodiment, further including absorbing the infrared radiation using a semiconductor infrared-absorbing layer thermally coupled to the deformable structure.

In a still further additional embodiment, the probing includes directing light that is detuned from a baseline resonance of the optical resonator.

In still another embodiment again, further including inducing an optical spring effect that modulates a mechanical stiffness of the deformable structure.

In a still further embodiment again, further including generating a temperature output based on a known temperature coefficient of frequency associated with the optical resonator.

In yet another additional embodiment, further including forming a spatially resolved thermal image based on outputs from an array of deformable structures and optical resonators.

In a yet further additional embodiment, the light signal is optically coupled from a probe source to the optical resonator using an integrated waveguide.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which forms a part of this disclosure.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIG. 1A illustrates an optomechanical cavity used in a thermal imager in accordance with an embodiment of the invention.

FIG. 1B illustrates a pixel-scale thermal imaging apparatus in accordance with an embodiment of the invention.

FIG. 2 illustrates a process for thermal imaging in accordance with an embodiment of the invention.

FIGS. 3A-3D illustrate views and characteristics of an optomechanical cavity used within a pixel-scale thermal imager in accordance with an embodiment of the invention.

FIGS. 4A-4D illustrate simulated optical modes of the optomechanical cavity in accordance with an embodiment of the invention.

FIG. 5 illustrates a graphical illustration of cavity optomechanical transduction as a function of laser-cavity detuning in accordance with an embodiment of the invention.

FIG. 6A illustrates an implementation of a pixel-scale thermal imager in accordance with an embodiment of the invention.

FIG. 6B illustrates an alternative configuration of the thermal imager in which additional mechanical support beams are incorporated into the suspended structure in accordance with an embodiment of the invention.

FIG. 6C illustrates a functional overview of the thermal imager's operation in accordance with an embodiment of the invention.

FIG. 7A illustrates a high-level implementation of the thermal imager incorporating an on-chip heater in accordance with an embodiment of the invention.

FIG. 7B illustrates a zoomed-in view of the heater-integrated cavity in accordance with an embodiment of the invention.

FIG. 8 illustrates two plots of performance tradeoffs in thermal imager design as a function of thermal conductance in accordance with an embodiment of the invention.

FIGS. 9A-9C illustrate experimental results related to cavity optomechanical thermometry in accordance with an embodiment of the invention.

FIG. 10A illustrates a chromium-based IR-absorbent sensing element cell in accordance with an embodiment of the invention.

FIG. 10B illustrates nickel-based IR-absorbent sensing element cell in accordance with an embodiment of the invention.

FIG. 10C illustrates an alternative nickel-based sensing element cells in accordance with an embodiment of the invention.

FIG. 10D illustrates a fabrication process of the sensing element in accordance with an embodiment of the invention.

### DETAILED DESCRIPTION

The detection of infrared radiation (IR) has multiple applications in areas such as meteorology, space, petroleum and safety, including motion detection and night vision. Current state-of-the-art techniques use either photodetection or thermal detection. While such systems have seen significant advancement in array size, frame rate, and integration, they are limited in terms of thermal sensitivity, spatial resolution, and miniaturization. These limitations can affect their ability to detect very small temperature differences, particularly in low-radiation or cryogenic environments. For these techniques to achieve very high sensitivity, they need cryogenic cooling, which can make them bulky and expensive while increasing power consumption, cost, and system size. Cooling of these types of transducers is essential due to the noise sources having the same physical origins as the signal being measured. Further, as pixel sizes decrease to improve resolution, thermal crosstalk increases, which can degrade image fidelity. Some techniques that do not require cooling base their measurement principles on detecting changes in mechanical properties of transducers, such as deformations of a structure or frequency changes on a mechanical resonator.

Optomechanical cavities in accordance with many embodiments combine optical resonators with mechanical structures whose physical displacement or resonance characteristics are influenced by incident thermal radiation. When IR is absorbed by the cavity structure, the resulting local temperature rise may induce changes in mechanical displacement, refractive index, or stress of the cavity structure. This mechanical change in the cavity can shift the optical resonance of the cavity, which can change the amplitude of the reflected laser. These shifts can be detected through laser probing or spectral monitoring to offer an enhanced thermal response compared to current bolometric systems. Changes in optical properties of the cavity may then be converted to measure thermal energy that was received by the imager.

Despite their high sensitivity and potential for nanoscale resolution, optomechanical cavities have not been widely adopted for thermal imaging applications, in part due to challenges in array scalability, difficulty in fabrication, and providing robust optical readout. Systems and methods in accordance with various embodiments address the above limitations by providing optomechanical cavities and sensing elements having form factors that are miniaturized sufficiently to support implementation of a pixelated array of thermal imagers. Systems and methods in accordance with many embodiments provide thermal imagers that are capable of measuring IR with high sensitivity and do not require cryogenic cooling to achieve high performance. In many embodiments, thermal imagers utilize multiple sensing elements that are made of IR-absorbent materials that each function as the equivalent of an individual pixel in an imager. Thermal imagers in accordance with a number of embodiments include optomechanical cavities that change mechanically in response to having thermal energy imparted on them, which in turn shift the optical resonance of the cavities. In numerous embodiments, thermal imagers can compute changes in optical resonance to determine the amount of thermal energy that was received.

Optomechanical cavities in accordance with many embodiments utilize an optomechanical optical-spring effect, which can be done through parametrically driven coupling between the optical and mechanical modes with intrinsic feedback. In various embodiments, the optical-spring effect provides a mechanism for dynamically modifying the effective mechanical stiffness of the cavity structure in response to optical input. Specifically, when a detuned laser is directed into the optical cavity, the cavity's stored photon population may vary with small mechanical displacements, giving rise to an optical gradient force. This gradient force may act back on the deformable cavity structure and can produce a restoring or destabilizing force depending on the detuning. In various embodiments, optomechanical cavities use the optical gradient force as a tunable control mechanism. Depending on the sign and magnitude of the detuning, optical gradient forces can either stiffen or soften the effective mechanical response of the suspended cavity. Optical gradient forces in accordance with a number of embodiments can help prevent mechanical saturation due to thermal over-expansion or improve the readout of weak thermal inputs by enhancing displacement. They help enable performance tuning, real-time adaptability, and parametric amplification schemes when modulated appropriately, which can enhance the utility of the sensor across different regimes of operation.

Thermal imagers in accordance with a variety of embodiments provide for increased noise reduction to assist with sustaining the amplitude of probing lasers. In several embodiments, thermal imagers are implemented as a chip-scale optical cavity and provide for sensitivities and resolutions that are close to the thermodynamic limits. In numerous embodiments, thermal imagers include a transducer architecture that does not measure specific thermal energy by direct displacement but rather measures thermal energy based on detected changes in the resonant frequency of optical cavities.

Thermal imagers in accordance with several embodiments create a feedback loop through such coupling. As thermal energy causes the cavity to deform and shift its resonance, the change in detuning may alter the intracavity optical power, which in turn modifies the optical force acting on the structure. In many embodiments, the stiffness of optomechanical cavities is changed, which can be particularly significant in high-Q cavities with strong optomechanical coupling, where even slight shifts in cavity geometry lead to appreciable changes in optical resonance.

In some embodiments, thermal imagers may leverage parametrically driven optical spring modulation, wherein the detuning is modulated at approximately twice the mechanical resonance frequency of the suspended structure. Thermal imagers in accordance with a variety of embodiments introduce time-varying stiffness and can result in amplification of thermally induced displacement through parametric resonance. Such a technique is beneficial for enhancing sensitivity to low-intensity thermal signals, as it allows small changes in cavity geometry to be more prominently expressed in the optical readout. The intrinsic feedback created by the interaction between the optical field and mechanical motion thus supports both passive sensitivity tuning and active displacement amplification within the thermal sensing framework.

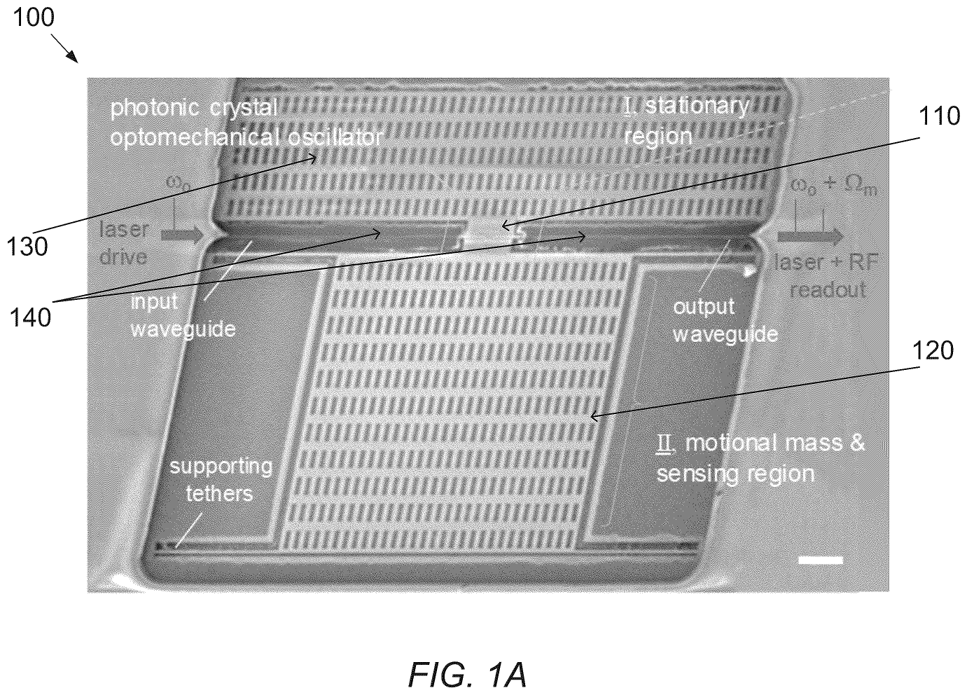

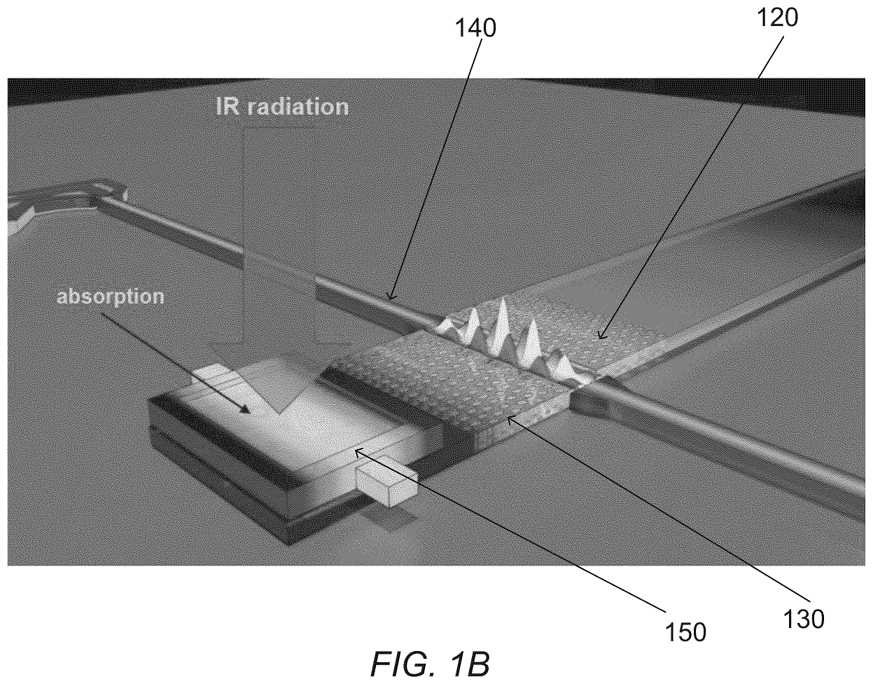

Referring to FIG. 1A, an optomechanical cavity used in a thermal imager in accordance with an embodiment of the invention is illustrated. Optomechanical cavity 100 includes a photonic crystal cavity 110 that is parametrically coupled to a mechanical resonant mode, and a side-attached motional mass and sensing region 120. In many embodiments, motional masses are mobile and are free to oscillate in the x-direction, with an oscillation RF frequency mainly given by the supporting tethers used for suspension. Optomechanical cavity 100 further includes a stationary mass 130 anchored in a silicon substrate wafer of the sensor chip. Stationary masses in accordance with several embodiments are fabricated as a layer of silicon membrane placed as the top layer of the silicon substrate wafer. Optomechanical cavity 100 further includes integrated waveguides 140, which couple the probing laser to a photonic crystal and an output detector. Integrated waveguides in accordance with various embodiments extend across the chiplet and may have an inverse tapered coupler on each side. Integrated waveguides can lead to less input/output power loss and reduce mechanical noise. Inertial sensors in accordance with several embodiments are able to be packaged in hermetic butterfly packages due to the use of integrated waveguides.

Optomechanical cavities in accordance with several embodiments are fabricated from materials with low optical loss, such as but not limited to silicon or silicon nitride, etc., and suspended by nanoscale tethers or support bridges extending to the substrate. Thermal input to the cavity structure can cause expansion or stress in the supporting tethers, motional mass and sensing region 120, resulting in deformation of the cavity and a corresponding shift in its resonance frequency. In various embodiments, input lasers, which may be introduced through the waveguide, are detuned relative to the baseline resonance of the cavity. As the cavity deforms in response to heat, the resonance condition changes, resulting in altered optical transmission or reflection characteristics. These changes may be used to determine the incident thermal energy.

Although a specific example of an optomechanical cavity is illustrated in this figure, any of a variety of setups can be utilized to perform processes similar to those described herein as appropriate to the requirements of specific applications in accordance with embodiments of the invention.

A pixel-scale thermal imaging apparatus in accordance with an embodiment of the invention is illustrated in FIG. 1B. Building on the optomechanical cavity illustrated in FIG. 1A, the thermal imaging apparatus further includes a pixel-scale sensing element 150. Thermal imaging apparatuses in accordance with various embodiments integrate pixel-scale sensing elements together with an optomechanical cavity and its associated probing laser. FIG. 1B illustrates the spatial arrangement of components that form a single imaging unit within an array-based system. Sensing elements in accordance with a number of embodiments include an IR-absorbent thermally responsive sensing element positioned to receive incident IR from a target scene. In various embodiments, probing lasers are co-integrated or optically coupled to the cavity through integrated waveguides to deliver a probe beam with a fixed or modulated detuning from the cavity's nominal resonance. As high bandwidth systems require small active mass and small thermal mass, systems and methods in accordance with several embodiments can fabricate a single pixel-scale thermal imager having an area of 10 um×10 um.

In many embodiments, sensing elements can absorb IR radiation to induce localized thermal expansion that shifts the optical cavity's resonance frequency. Sensing elements in accordance with selected embodiments are fabricated and placed on top of the stationary mass. As thermal energy is absorbed by the sensing element, the stationary mass may expand to change the slot width of the optomechanical cavity. In certain embodiments, sensing elements may be fabricated and placed on top of the motional mass. Sensing elements may absorb incident thermal energy and cause the motional mass and supporting tethers to similarly expand and change the slot width of the optomechanical cavity. In several embodiments, changes to the slot width of the optomechanical cavity lead to changes in its resonant frequency.

Probing lasers in accordance with several embodiments interact with the cavity such that changes in resonance are translated into changes in the transmitted or reflected optical signal. Optical signals output by the waveguides may be collected by a photodetector or readout circuit, which may undergo further analysis to provide a pixel-level thermal readout to enable the formation of a spatially resolved thermal image when similar elements are arranged in a sensor array.

In a number of embodiments, sensing elements are fabricated using amorphous silicon and include amorphous silicon-based tethers on the side of the sensing elements to better confine thermal energy due to their lower thermal conductivity. Amorphous silicon-based tethers in accordance with many embodiments can decrease noise equivalent power and increase device sensitivity. In certain embodiments, amorphous silicon-based tethers may be deposited using CVD to make an area with low thermal conductivity behind the motional mass. Changes in the temperature of the heater element will cause the mass to expand, narrowing the slot cavity and changing the mechanical frequency of the device. Lower thermal conductivity may prevent the region from leaking heat to the surroundings.

Thermal imagers in accordance with various embodiments include a tunable laser, a laser controller, and a data acquisition (DAQ) tool. In certain embodiments, thermal imagers further include an optical fiber isolator, a polarization controller, tapered fibers, an optical detector, and various data analysis instruments. The tunable laser may be connected to the optical fiber isolator and the polarization controller before being fed and coupled to the optomechanical cavity. Output tapered fibers in accordance with several embodiments can be connected to the optical detector to facilitate analysis of the laser signal on the data analysis instruments, such as, but not limited to, an electronic spectrum analyzer (ESA), a power meter, and a frequency counter. The tunable laser signal can also be sent into the laser controller subsystem and connected to a double feedback loop used to stabilize the laser. In many embodiments,

Although a specific example of a pixel-scale sensing element is illustrated in this figure, any of a variety of setups can be utilized to perform processes for detecting incident IR similar to those described herein as appropriate to the requirements of specific applications in accordance with embodiments of the invention.

Thermal imagers in accordance with many embodiments utilize laser-driven narrow-linewidth optomechanical oscillators, with laser-RF readout at the thermodynamic fluctuation limits, integrated in the silicon CMOS-compatible platform and infrastructure. In various embodiments, planar-integrated sensing elements operate similarly to optical pixels in conventional imaging devices. Sensing elements in accordance with selected embodiments operate at room temperature and have a strong optomechanical transduction (dispersive coupling g*/2π of up to 783 kHz), a large temperature coefficient of frequency shift (0.44% per Kelvin), with designed distinguishable frequency shifts (ΔΩₘ) of 1.7-kHz and 440-Hz of the mechanical oscillator respectively at the 200-fW/Hz^{1/2} and 80-fW/Hz^{1/2} noise-equivalent powers.

At finite bath temperatures, intrinsic thermomechanical noise can result in the resonator motional variations and hence the ultimate displacement sensitivity. This can be described by the displacement spectral density Sₓ(ω), the resulting resonator phase fluctuations

$${S}_{ϕ} ( ω ) = {S}_{x}^{2} ( ω ) {〈 x 〉}^{2} ,$$

and frequency fluctuations

$${S}_{ω} ( ω ) = {[ \frac{{ω}_{o}}{2 Q} ]}^{2} {S}_{ϕ} ( ω ) ,$$

where ω₀ is the resonator angular frequency and <x> is the resonator root-mean-square amplitude. The resulting thermomechanical frequency fluctuation δf_{TM} is described by

$$\sqrt{\frac{{k}_{B} T}{{E}_{c}} \frac{{ω}_{o} B}{Q}} ,$$

where B is the signal bandwidth and E_{c} the resonator carrier energy. For thermal imaging, one defines the temperature coefficient of frequency shift

$$( TCF ) = \frac{1}{{f}_{0}} \frac{δ f}{δ T} .$$

Multiplied by the thermal conductance G (W/K) through tether support beams and divided by the TCF and carrier frequency ω₀, the equivalent power fluctuation from thermomechanical noise and its spectral density δP_{TM} can be computed. Thermomechanical δf_{TM} and δP_{TM} may be derived from the equipartition theorem, and the fluctuation-dissipation framework in oscillation mode can provide a further improved estimate of frequency stability.

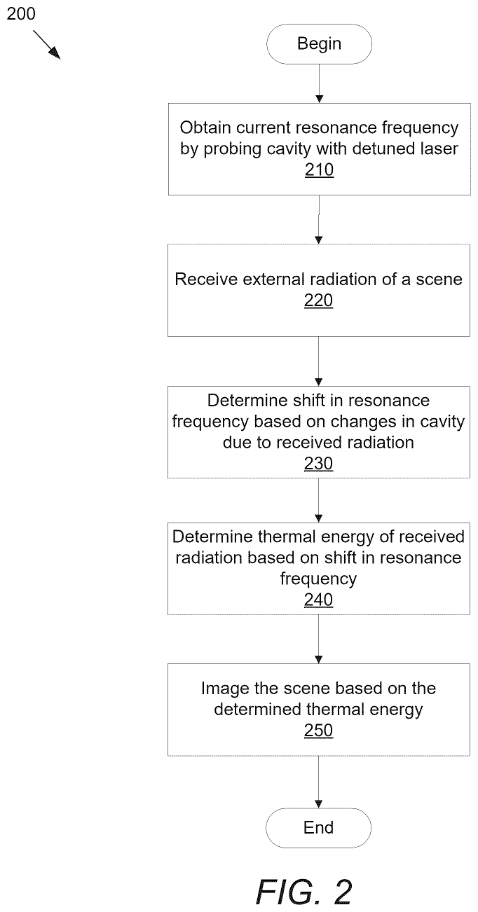

A process for thermal imaging in accordance with an embodiment is illustrated in FIG. 2. Process 200 obtains (210) a current resonance frequency by probing an optomechanical cavity with a detuned laser. Processes in accordance with many embodiments obtain the current resonance frequency by probing the cavity with a continuous-wave laser that is tuned slightly off-resonance with respect to the optomechanical cavity's resonance frequency. Probing lasers in accordance with a number of embodiments are directed toward the cavity via integrated waveguides, providing a probe signal that is sensitive to changes in the cavity's resonance frequency.

Process 200 receives (220) external radiation from a scene. Incident IR from a thermal source may be absorbed by a sensing element, which includes an IR-absorbent layer thermally coupled to the optomechanical cavity. In many embodiments, sensing elements absorb incident IR energy to create localized heating and mechanical deformation of the cavity structure, which leads to a shift in the cavity's resonance condition.

Process 200 determines (230) shift in resonance frequency based on changes in the cavity due to received radiation. As the resonance shifts, the degree of detuning between the laser and the cavity changes. This results in a corresponding change in the optical transmission or reflection from the cavity.

Process 200 determines (240) thermal energy of received radiation based on the shift in resonance frequency. Processes in accordance with several embodiments utilize signal processing and data analysis instruments such as photodetectors to determine the incident thermal energy based on the shift in resonance frequency. In some embodiments, signal processing circuits can interpret the variation in optical intensity or phase as a function of time. Shifts in resonance frequency may be computed as a function of change in the width of the cavity, which changes as a function of received thermal energy:

$${Ω}_{m}^{′} = \sqrt{{Ω}_{m}^{2} + ( \frac{2 {\vert \hat{a} \vert}^{2} {g}_{om}^{2}}{( {( {ω}_{l} - {ω}_{c} + {g}_{om} {x}_{s} )}^{2} + {( 1 / 2 τ )}^{2} ) {ω}_{c} {m}_{x}} ) ( {ω}_{l} - {ω}_{c} + {g}_{om} {x}_{s} ) .} \qquad ( 1 )$$

In equation 1, Ωₘ is fundamental mechanical resonant frequency, Ω′ₘ is the shifted resonant frequency, |â|² is the averaged intracavity photon energy, gₒₘ is the optomechanical coupling rate, mₓ is the effective mass, 1/τ is the optical cavity decay rate, ω_{c} is the resonant frequency, and ωₗ is the driving optical frequency.

The relationship between power measured by the spectrum analyzer and transmitted optical power can be illustrated as:

$${S}_{x} ( Ω ) = \frac{\frac{2 {Γ}_{m} {k}_{B} T}{{m}_{x}}}{{( {Ω}_{m}^{2} - {Ω}^{2} )}^{2} + {( {ΩΓ}_{m} )}^{2}} . \qquad ( 2 )$$

$$Γ = - \frac{{ω}_{0}}{2 {Ω}_{m} {L}_{om}^{2} m} ( \frac{2 κ}{{κ}^{2} + 4 {Δ}^{2}} ) [ \frac{\frac{κ}{2}}{{( Δ - {Ω}_{m} )}^{2} + {( \frac{κ}{2} )}^{2}} - \frac{\frac{κ}{2}}{{( Δ + {Ω}_{m} )}^{2} + {( \frac{κ}{2} )}^{2}} ] . \qquad ( 3 )$$

$${PSD}_{ESA} ( ω ) = 10 \cdot log [ \frac{{( {g}_{ti} {P}_{m} ( ω ) )}^{2}}{Z} \cdot 1000 ] . \qquad ( 4 )$$

gₜᵢ is the impedance gain of the photodetector, which can generate an output voltage gₜᵢPₘ. The spectrum analyzer calculates the optical sideband in units

$$\frac{{V}^{2}}{Z} ,$$

where Z is the impedance. Power spectral density (PSD) may further be expressed in terms of dBm/Hz.

Process 200 images (250) the scene based on the thermal energy. Processes in accordance with some embodiments construct a spatially resolved map representing the distribution of thermal energy across the scene based on the output measured across multiple sensor pixels.

While specific processes are described above with reference to FIG. 2, any of a variety of methods for detecting acceleration using optomechanical inertial sensors in any of a variety of different modes can be utilized as appropriate to the requirements of specific applications in accordance with various embodiments of the invention.

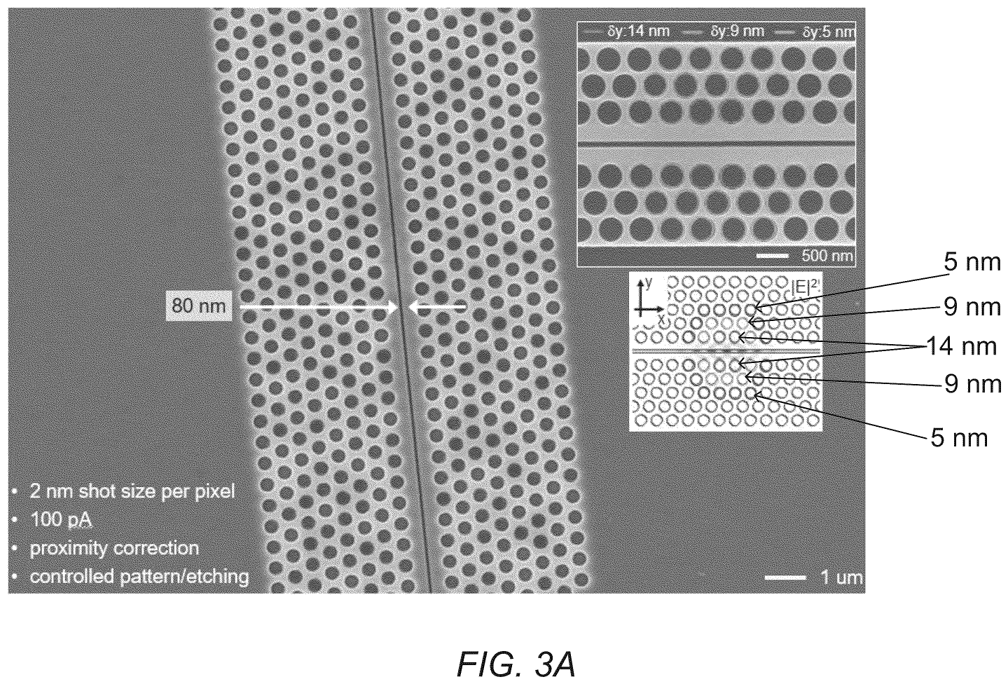

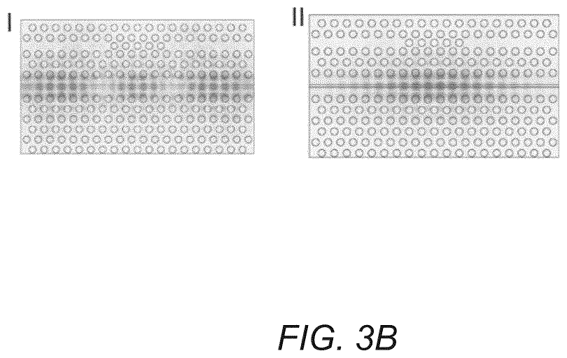

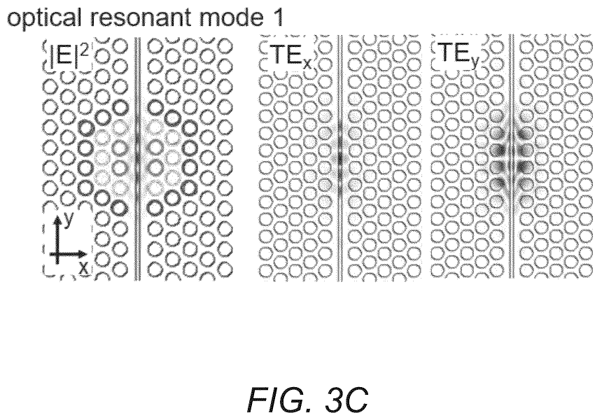

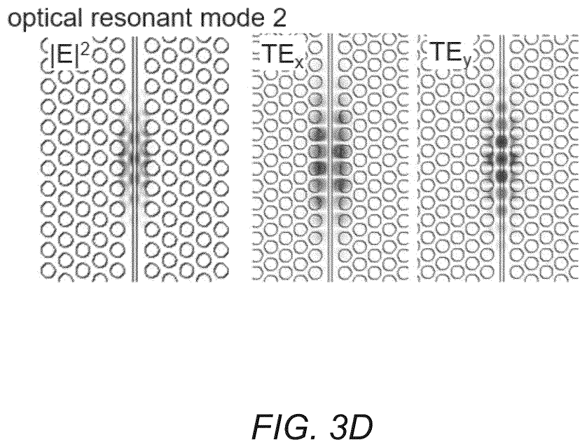

FIGS. 3A through 3D illustrate views and characteristics of an optomechanical cavity used within a pixel-scale thermal imager in accordance with an embodiment of the invention. A top-down view of an optomechanical cavity structure in accordance with an embodiment is illustrated in FIG. 3A. FIG. 3A illustrates how an optomechanical cavity is fabricated along with certain parameters associated with fabrication. In various embodiments, optomechanical cavities are arrays of holes with a constant lattice. Optomechanical cavities in accordance with a number of embodiments include an intentionally introduced defect where the lattice is displaced slightly. In the example illustrated by FIG. 3A, an outer ring of lattice holes is displaced by 5 nm on the two sides of the cavity, a middle ring of lattice holes is displaced by 9 nm on the two sides of the cavity, and an inner ring of lattice holes is displaced by 14 nm on the two sides of the cavity.

FIG. 3B illustrates a distribution of the electric field in the optomechanical cavity in accordance with an embodiment of the invention. FIG. 3B illustrates the fundamental mode of a crystal with a photonic crystal waveguide in II and the first mode in I. In many embodiments, most of the electric field is confined inside the center slot, which makes it possible to build radiation pressure.

FIGS. 3C and 3D illustrate the x and y components of the fundamental mode and the first mode. In many embodiments, optomechanical cavities include a thermomechanically responsive region configured to deform upon absorption of infrared radiation. Optomechanical cavities in accordance with some embodiments are fabricated with 80 nm spacing such that the cavity walls are as smooth as possible to avoid loss during laser transmission.

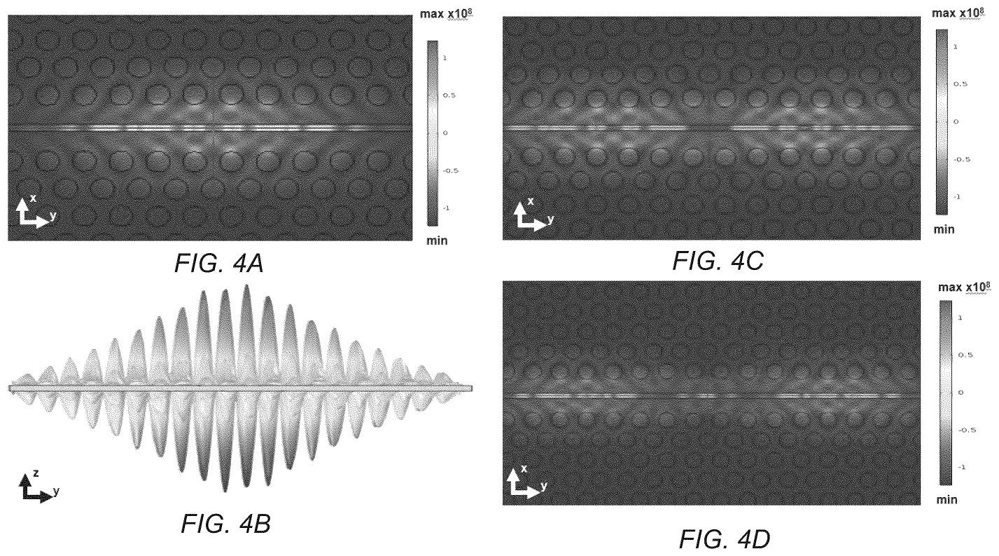

Simulated optical modes of the optomechanical cavity in accordance with an embodiment are illustrated in FIGS. 4A-D. These simulations show the spatial distribution of the electric field intensity under various thermal loading and cavity deformation conditions. FIG. 4A illustrates a fundamental optical mode of the cavity. FIG. 4B illustrates a x-z view of the zoomed-in z-component electric field. FIG. 4C illustrates a second-order mode. FIG. 4D illustrates a third-order mode. As thermal energy is absorbed by the cavity, the resulting mechanical deformation shifts the mode profile, either by altering the effective refractive index landscape or by geometrically perturbing the resonant boundary conditions. These shifts are directly correlated with the sensor's readout signal, allowing the use of optical mode displacement as a proxy for incident infrared energy. The simulated modes can provide design validation for cavity geometries and highlight regions of strong optomechanical coupling.

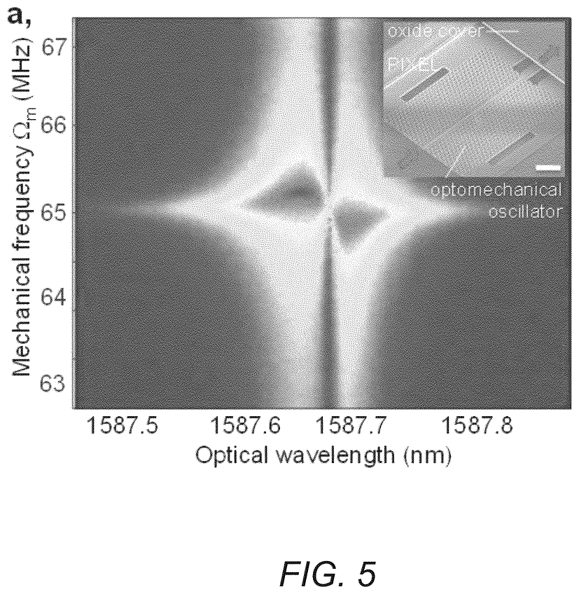

A graphical illustration of cavity optomechanical transduction as a function of laser-cavity detuning in accordance with an embodiment is illustrated in FIG. 5. FIG. 5 illustrates a 2D map of 65 MHz to 112 MHz cavity optomechanical transduction versus laser-cavity detuning, with vacuum gₒₘ/2π≈783 kHz. FIG. 5 illustrates a characteristic response of the thermal imager, as a function of the wavelength of the laser used to drive it. Lasers tuned above resonance are called blue-detuned, which can stiffen the cavity and drive the cavity into oscillation, whereas lasers tuned to a frequency below the resonant frequency are called red-detuned, which allows the cavity to soften and cool. As a proof of concept, FIG. 5 illustrates that thermal imagers and associated optomechanical cavities in accordance with several embodiments respond correctly when wavelengths of the probing laser are changed, similar to when the wavelengths change due to changes in the slot width of the optomechanical cavities. Thermal imagers in accordance with many embodiments have a large mechanical frequency (65-100 MHZ), and a large frequency shift (˜1 MHZ). Increased frequency ranges and frequency shift ranges allow for an increased maximum bandwidth that can be detected, thereby allowing the thermal imager to be more responsive to larger changes in thermal energy.

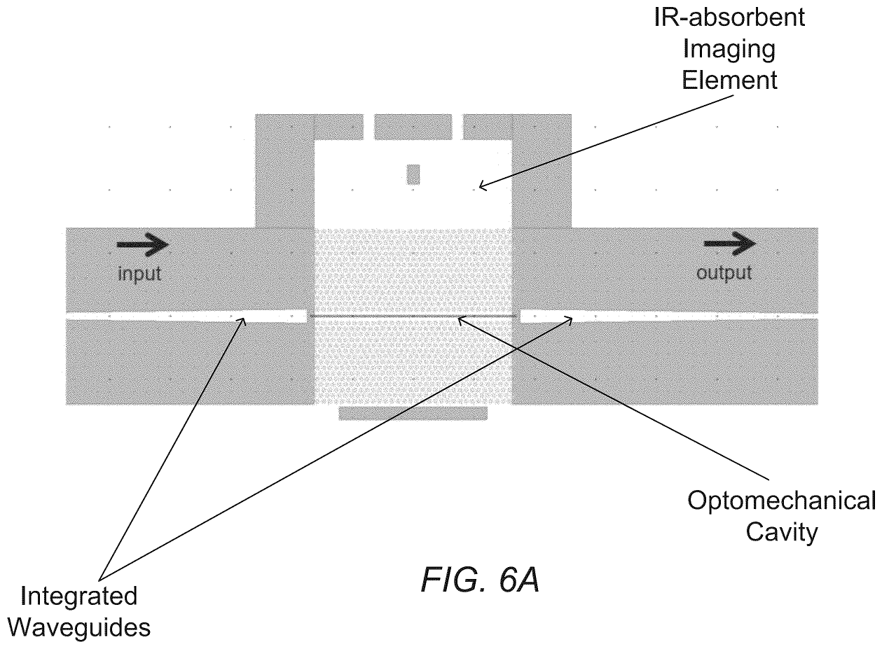

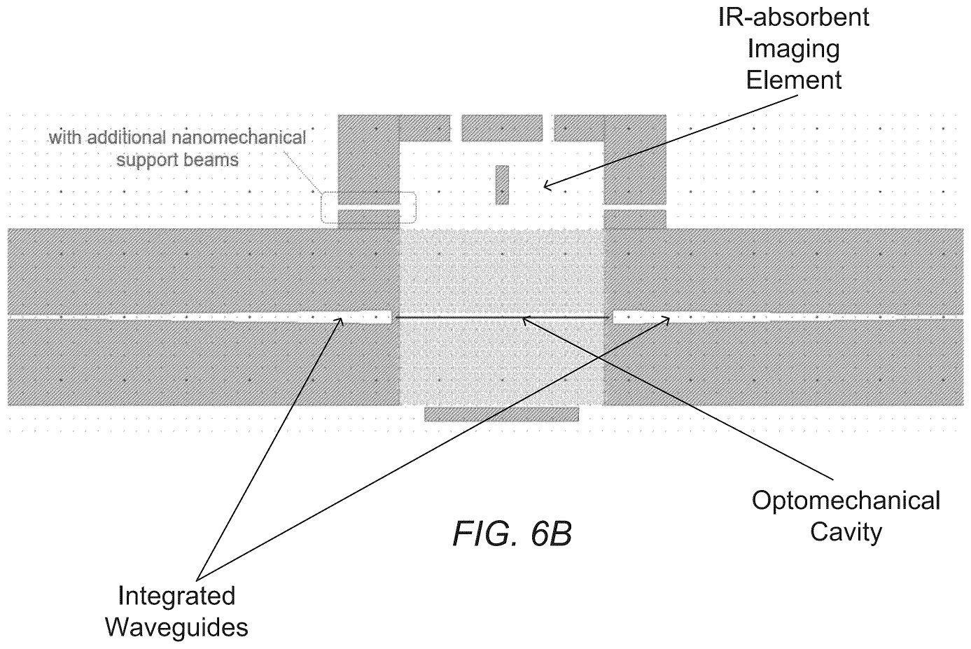

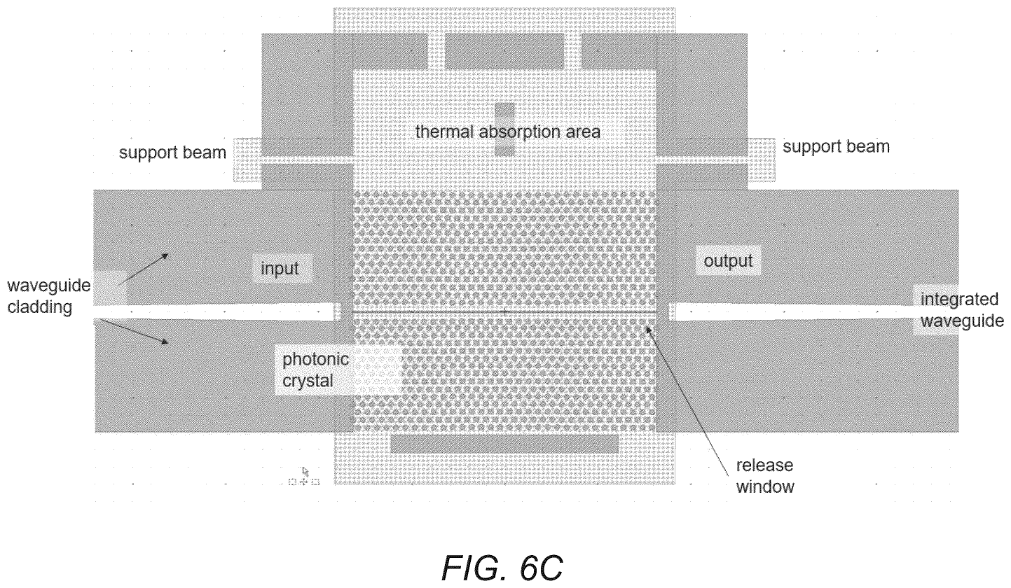

An implementation of a pixel-scale thermal imager in accordance with an embodiment is illustrated in FIG. 6A. Thermal imagers in accordance with several embodiments include a suspended optomechanical cavity structure integrated with an IR-absorbing layer and a driving laser input. In a variety of embodiments, IR-absorbing layers are anchored and suspended over a silicon substrate to enable mechanical deformation in response to thermal loading. Lasers may be directed at the cavity through integrated waveguides, allowing precise detuned probing of the cavity's resonance condition.

An alternative configuration of the thermal imager in which additional mechanical support beams are incorporated into the suspended structure in accordance with an embodiment is illustrated in FIG. 6B. Support beams in accordance with numerous embodiments enhance mechanical stability and reduce noise from extraneous vibration. Additional support beams can assist in containing received thermal energy to enable a more precise control over the deformation response to absorbed thermal energy. The configuration illustrated in FIG. 6B may be particularly advantageous in applications requiring increased robustness or better-defined thermal boundaries.

A functional overview of the thermal imager's operation in accordance with an embodiment is illustrated in FIG. 6C, which outlines the sensing mechanism from receiving incident IR to optical output. In various embodiments, thermal imagers absorb incident IR at the thermal absorption area through the sensing element. Absorption of thermal energy can lead to cavity deformation that shifts the optical resonance. Detuned lasers may be utilized to probe the modified cavity through the integrated waveguide, and the resulting optical signal can be transmitted to data analysis instruments. A signal processing circuit then converts the variation in cavity resonance frequency into a quantifiable thermal reading, which can be rendered as part of a spatial thermal image when implemented in an array.

Although specific examples of a pixel-scale thermal imager are illustrated in this figure, any of a variety of setups can be utilized to perform processes for detecting incident IR similar to those described herein as appropriate to the requirements of specific applications in accordance with embodiments of the invention.

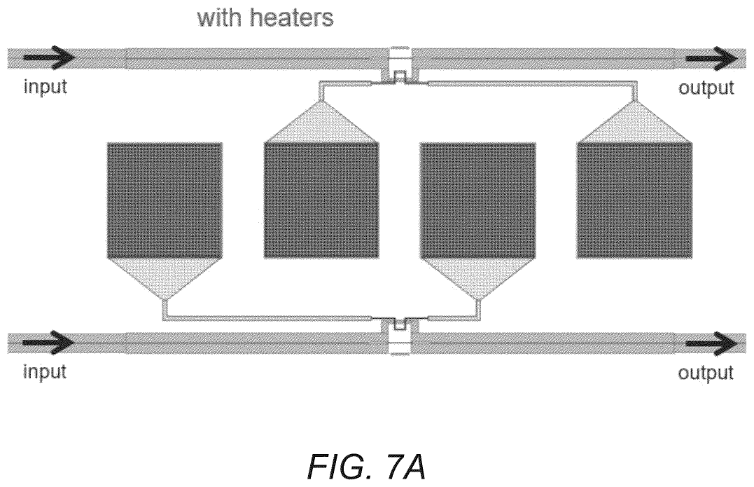

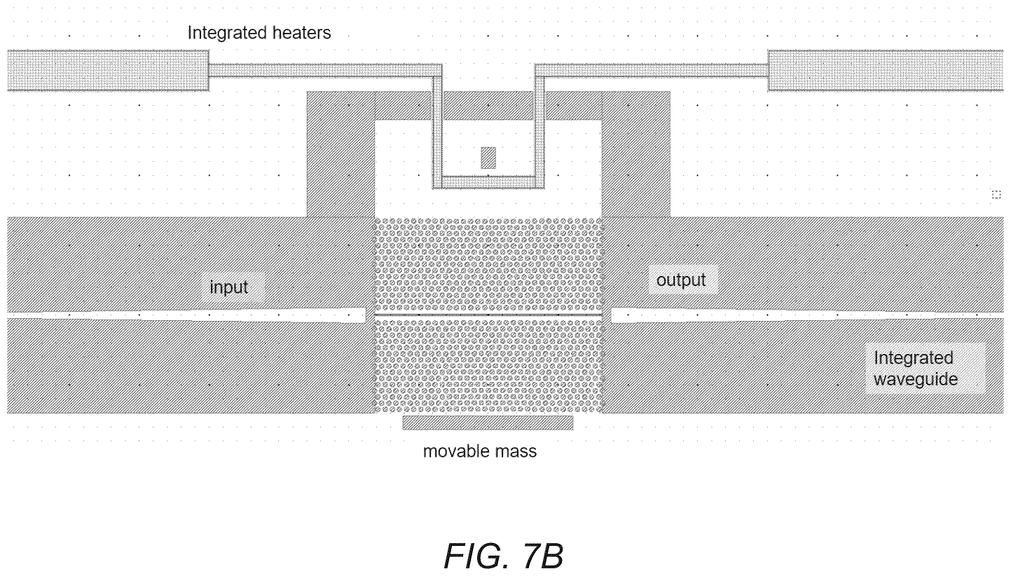

A high-level implementation of the thermal imager incorporating an on-chip heater in accordance with an embodiment is illustrated in FIG. 7A. In many embodiments, incorporating an on-chip heater can provide localized thermal excitation for characterization, calibration, or test purposes. Heaters in accordance with various embodiments may be formed from a resistive metallic trace or other thermoelectric element integrated near the suspended optomechanical cavity. By applying a controlled electrical input to the heater, thermal imagers with on-chip heaters can simulate thermal loading without relying on external infrared sources. This allows for repeatable thermal modulation, facilitating device tuning and validation of the cavity's resonance response to known thermal inputs. In some embodiments, on-chip heaters can be used to add a small offset to the sensor shifting the mechanical frequency to improve readout.

A zoomed-in view of the heater-integrated cavity in accordance with an embodiment is illustrated in FIG. 7B. The physical proximity and thermal coupling between the heater structure and the suspended cavity are illustrated in FIG. 7B. In various embodiments, localized heating can be delivered more directly to the sensing element to induce thermal expansion in the mechanical structure, which leads to deformation of the cavity and a corresponding shift in its optical resonance. Heater-integrated thermal imagers in accordance with a variety of embodiments support built-in test and calibration modes, enabling real-time adjustment of sensitivity, range, or baseline compensation without relying solely on external environmental stimuli.

Although specific examples of a thermal imager with integrated heaters are illustrated in this figure, any of a variety of setups can be utilized to perform processes for detecting thermal energy similar to those described herein as appropriate to the requirements of specific applications in accordance with embodiments of the invention.

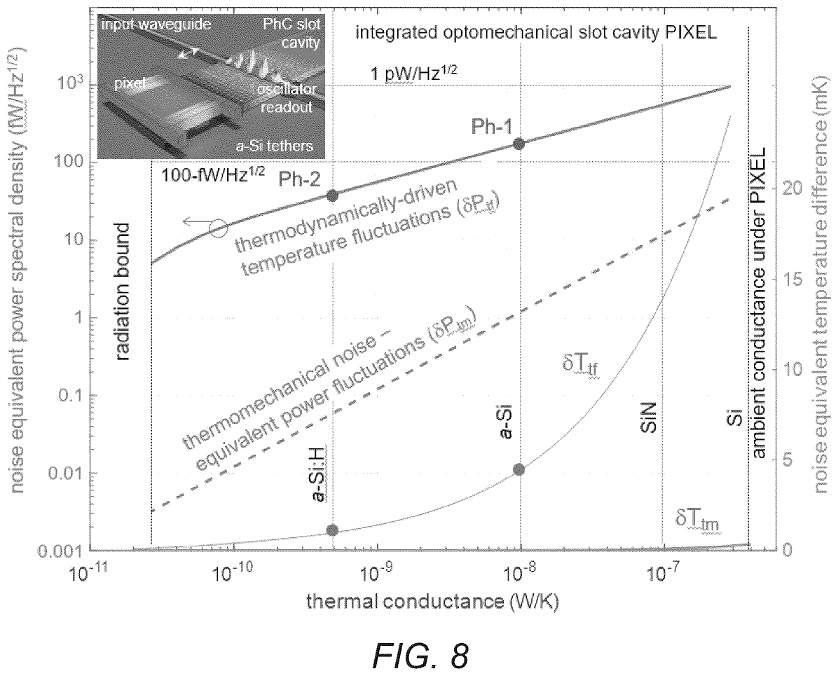

Two plots of performance tradeoffs in thermal imager design as a function of thermal conductance in accordance with an embodiment are illustrated in FIG. 8. The first plot presents the noise-equivalent temperature difference (NETD) versus thermal conductance. NETD represents the minimum detectable temperature difference the sensor can resolve, and is a key figure of merit for thermal imaging sensitivity. The plot demonstrates how NETD varies depending on the thermal conductance of the absorber-cavity system: higher conductance generally leads to lower thermal time constants but can increase noise, resulting in higher NETD.

The second plot in FIG. 8 shows noise-equivalent power (NEP) spectral density versus thermal conductance. NEP describes the minimum power input required to generate a signal equal to the noise floor, typically expressed in watts per square root hertz. As thermal conductance increases, the NEP spectrum shifts, indicating changes in the sensor's responsiveness to weak thermal signals.

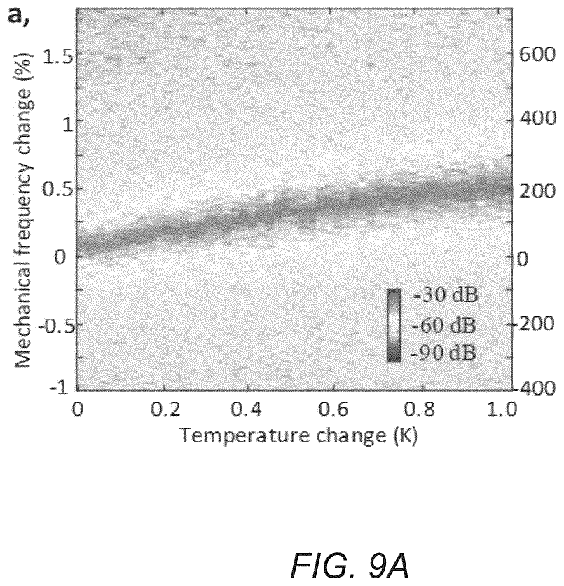

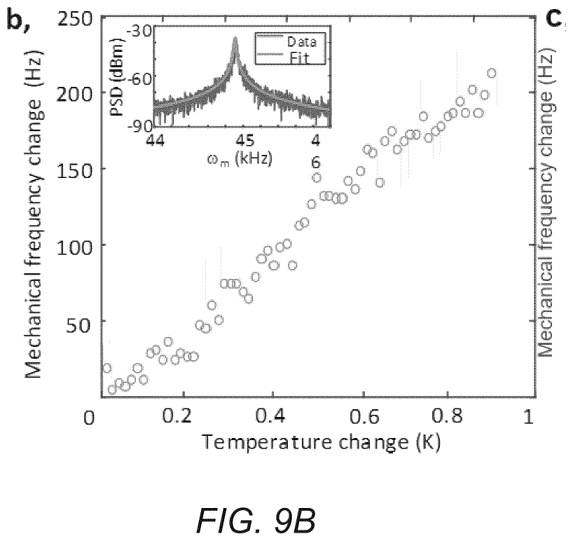

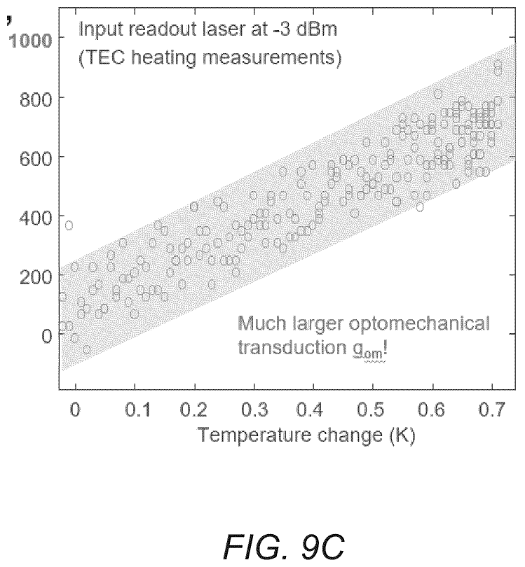

FIGS. 9A through 9C illustrate experimental results related to cavity optomechanical thermometry, showcasing how resonance-based sensing elements respond to localized thermal input. A thermal response map of a pixel-scale thermal imager in accordance with an embodiment is illustrated in FIG. 9A. FIG. 9A illustrates how resonance frequency shifts vary across the cavity surface when exposed to a known thermal gradient or localized heating source. This map demonstrates the sensing element's ability to resolve spatially varying thermal input with high contrast and serves as an early proof of the thermal imaging functionality.

A plot of thermal responses in accordance with an embodiment is illustrated in FIG. 9B. In these measurements, thermal imagers are configured such that the optomechanical cavity is mounted on a thermoelectric cooler to measure the TCP:

$$TCF = \frac{1}{{f}_{0}} \frac{δ f}{δ T} .$$

Both FIGS. 9A and 9B illustrate a 200 Hz frequency shift with 1° K temperature change: TCF≈0.44%±0.04%/K center frequency shift, much above 4 ppm of ADev at 1-sec. TCF is linear within 0.5° K, hence enabling a large dynamic range.

A plot of thermal responses for a thermal imager with 10× larger optomechanical transduction in accordance with an embodiment is illustrated in FIG. 9C. The optomechanical transduction in FIG. 9C is approximately gₒₘ: TCF≈1.803%/K, or equivalently 1.371 kHz/K (at −3 dBm). For the same imager at −1 dBm input readout laser power, the TCF can reach approximately ≈5.17%/K, or equivalently 3.93 kHz/K.

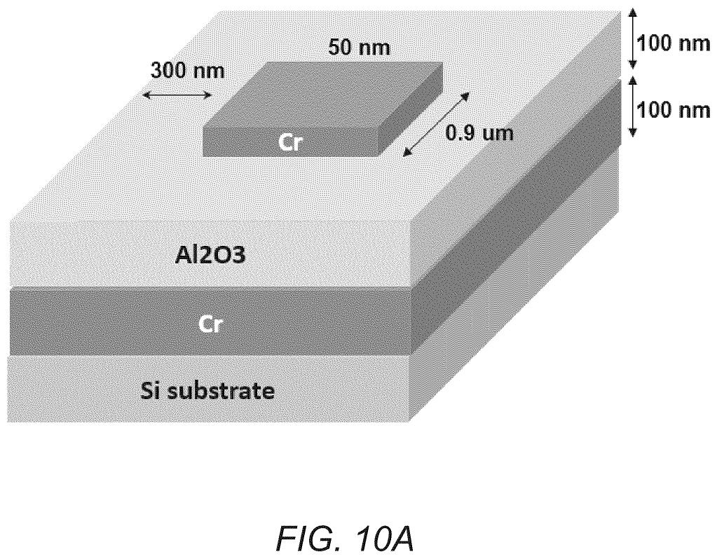

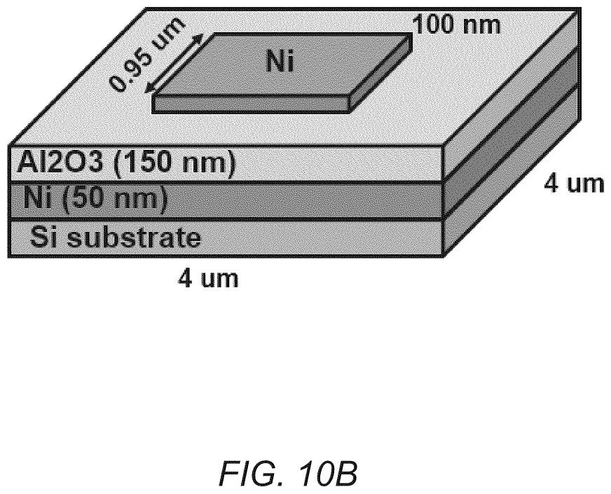

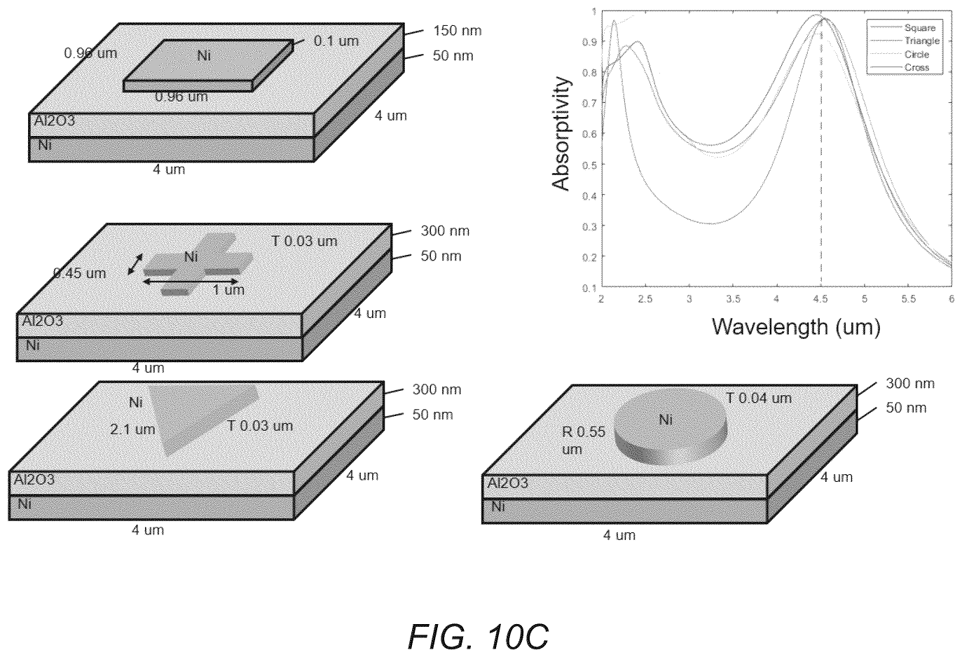

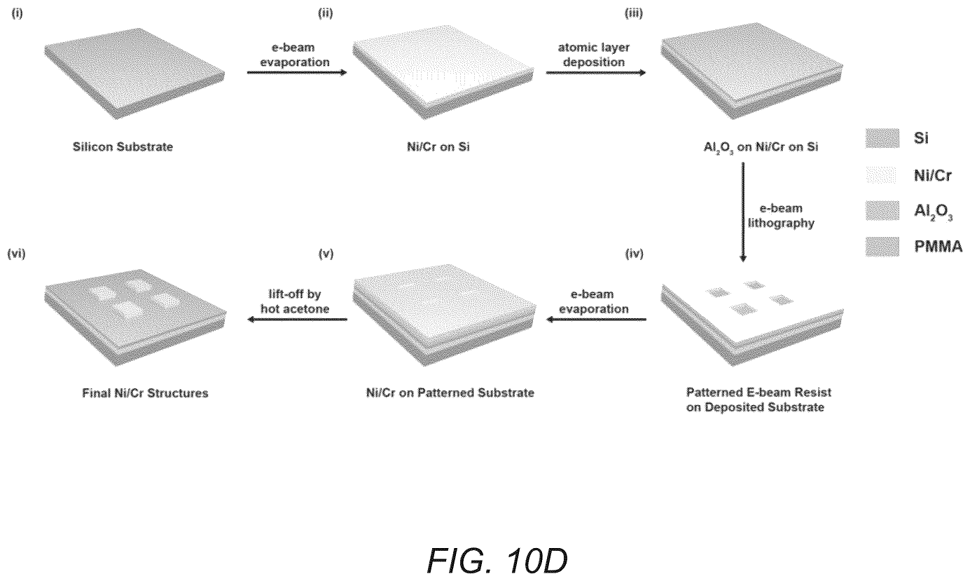

FIGS. 10A-10D relate to the deposition and fabrication of the IR-absorbent sensing element used in the optomechanical thermal imaging system. Sensing elements in accordance with numerous embodiments are designed to detect radiation in the 4-5 micron wavelength band, which is primarily used to detect mid-infrared thermal radiation from warm objects (300-700 K), including human bodies, machinery, and terrain, and is also sensitive to gas emissions like CO and CO₂. A chromium-based IR-absorbent sensing element cell in accordance with an embodiment is illustrated in FIG. 10A. FIG. 10A illustrates a geometric alignment between the chromium absorber and the suspended mechanical cavity structure beneath it. In many embodiments, chromium layers are selectively deposited to match the dimensions of the cavity substrates and optimized to achieve efficient absorption of IR. Chromium layers in accordance with several embodiments are single layers etched to have a protruding column to facilitate IR absorption. Its deposition may be carried out using sputtering or electron beam (e-beam) evaporation, followed by patterning through lithographic and lift-off techniques to avoid covering tether regions or optical coupling interfaces. Aluminum oxides (Al₂O₃) may be deposited on top of the chromium based on the pattern of the chromium layer. Chromium-based IR-absorbent sensing element cells in accordance with many embodiments are able to achieve near-unity absorption at various desired IR frequencies.

A nickel-based IR-absorbent sensing element cell in accordance with an embodiment is illustrated in FIG. 10B. Similar to the chromium configuration, nickel layers in accordance with a variety of embodiments may be deposited over layers of substrate surface to create a thermally responsive region with improved thermal conductivity and mechanical resilience. Nickel layers in accordance with several embodiments are also fabricated as single layers having a protruding column to facilitate IR absorption. Al₂O₃ may be deposited on top of the chromium based on the pattern of the nickel layer. In a single IR-absorbent sensing element, there may be four to six sensing element cells. Nickel-based sensing elements can achieve near unity absorption at various desired IR frequencies.

Alternative nickel-based sensing element cells in accordance with an embodiment are illustrated in FIG. 10C. Nickel layers may be etched to have a square-shaped, cross-shaped, triangular-shaped, and/or circular-shaped protruding component, each having a different profile in terms of absorptivity of IR of different wavelengths. In various embodiments, selective deposition strategies of the nickel layer can enhance thermal localization and reduce excess thermal mass, improving the system's responsiveness and sensitivity to incident IR radiation.

A fabrication process of the sensing element in accordance with an embodiment is illustrated in FIG. 10D. In various embodiments, silicon substrates have nickel, chromium, or another selected material deposited on them through e-beam evaporation. Al₂O₃ in accordance with some embodiments is deposited on the dual Ni/Cr silicon substrate through atomic layer deposition. Polymethyl methacrylate (PMMA) in accordance with certain embodiments may be deposited and etched using e-beam lithography. In many embodiments, processes deposit another Ni/Cr layer based on the pattern etched on the PMMA through another e-beam evaporation. Final layers of Al₂O₃ may be deposited using lift-off by hot acetone to obtain the sensing element. In many embodiments, lattice constants of deposits may be adjusted to give different spacing to the imager to allow the imager to be sensitive to different wavelengths.

Although specific examples of sensing elements and fabrication processes are illustrated in FIGS. 10A-D, any of a variety of setups can be utilized to fabricate sensing elements similar to those described herein as appropriate to the requirements of specific applications in accordance with embodiments of the invention.

Although specific methods of train-time data purification using generative models are discussed above, many different methods of data purification to provide models with safer and more robust training can be implemented in accordance with various embodiments of the invention. For example, one of ordinary skill in the art will appreciate that methods of training and purification described above can be implemented in a variety of computing and/or networking applications. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. An optomechanical thermal imager, comprising:
at least one optomechanical thermal sensor, wherein the optomechanical thermal sensor comprises:
a deformable structure configured to receive infrared radiation and undergo a mechanical deformation in response to thermal energy from the radiation;
an optical resonator mechanically coupled to the deformable structure and configured to shift in resonance condition in response to the deformation; and
a probe source configured to emit light toward the optical resonator at a wavelength near the resonance condition; and
a detector configured to receive light from the optical resonator and generate an output based on a shift in the resonance condition associated with the received infrared radiation.

2. The optomechanical thermal imager of claim 1, wherein the deformable structure further comprises:
a stationary support portion anchored to a substrate; and
a suspended mass coupled to the stationary support portion, wherein the suspended mass forms at least a portion of the optical resonator or being mechanically coupled to a portion of the resonator such that deformation of the suspended mass causes a shift in the resonator's resonance condition.

3. The optomechanical thermal imager of claim 1, wherein the deformable structure further comprises a semiconductor infrared-absorbent layer thermally coupled to the deformable structure and configured to convert incident infrared radiation into localized heat.

4. The optomechanical thermal imager of claim 1, wherein the optical resonator comprises a photonic crystal cavity suspended above a substrate.

5. The optomechanical thermal imager of claim 1, wherein the optical resonance condition comprises a resonance frequency that changes with mechanical deformation of the resonator.

6. The optomechanical thermal imager of claim 1, wherein the probe source is configured to emit light at a wavelength detuned from a baseline resonance of the optical resonator.

7. The optomechanical thermal imager of claim 6, wherein the detuning induces an optical gradient force that modulates an effective mechanical stiffness of the structure.

8. The optomechanical thermal imager of claim 1, wherein the output comprises a temperature value determined based on a known temperature coefficient of frequency associated with the optical resonator.

9. The optomechanical thermal imager of claim 1, wherein the at least one optomechanical thermal sensor is arranged in an array to form an optomechanical thermal imager.

10. The optomechanical thermal imager of claim 1, further comprising a signal processor configured to generate a spatially resolved thermal image based on the output of the detector.

11. The optomechanical thermal imager of claim 1, further comprising an integrated waveguide for optical coupling from the probe source to the optical resonator.

12. A method of sensing infrared radiation using an optomechanical cavity, the method comprising:
absorbing infrared radiation at a deformable structure thermally coupled to an optical resonator;
inducing a deformation in the deformable structure in response to absorption of the infrared radiation;
shifting an optical resonance condition of the optical resonator due to the deformation;
probing the optical resonator with a light signal; and
detecting a change in the optical signal that indicates the resonance shift and corresponds to the absorbed infrared radiation.

13. The method of claim 12, wherein the deformable structure comprises a suspended structure coupled to the optical resonator.

14. The method of claim 12, wherein the optical resonator comprises a photonic crystal cavity suspended above a substrate.

15. The method of claim 12, further comprising absorbing the infrared radiation using a semiconductor infrared-absorbing layer thermally coupled to the deformable structure.

16. The method of claim 12, wherein the probing comprises directing light that is detuned from a baseline resonance of the optical resonator.

17. The method of claim 16, further comprising inducing an optical spring effect that modulates a mechanical stiffness of the deformable structure.

18. The method of claim 12, further comprising generating a temperature output based on a known temperature coefficient of frequency associated with the optical resonator.

19. The method of claim 12, further comprising forming a spatially resolved thermal image based on outputs from an array of deformable structures and optical resonators.

20. The method of claim 12, wherein the light signal is optically coupled from a probe source to the optical resonator using an integrated waveguide.
